(19) United States
(12) Patent Application Publication
(10) Pub. No.: US 2010/0056256 A1
(43) Pub. Date: Mar. 4, 2010

(54) APPARATUS AND METHOD HAVING A SLIDER DISPLAY

(75) Inventors: Andrzej Surmacz, Las Vegas, NV (US); Nizdil C. Mark, Montrose, CA (US)

Correspondence Address: PATENT INGENUITY, PC, 520 BROADWAY, SUITE 350, SANTA MONICA, CA, 90401, US

(73) Assignee: INTEGRATED GROUP ASSETS INC., Dallas, TX (US)

(21) Appl. No.: 12/618,962

(22) Filed: Nov. 16, 2009

Related U.S. Application Data
(63) Continuation-in-part of application No. 11/938,713, filed on Nov. 12, 2007.

(51) Int. Cl. A63F 9/24; A63F 13/00

(52) U.S. Cl. 463/20; 463/30; 463/43; 463/25

(57) ABSTRACT

An apparatus includes a slider controller that displays, prior to initiation of a base game, a slider display having a plurality of payline quantity indicia and a plurality of wager category indicia. In addition, the apparatus has a payline quantity adjuster that adjusts a potential payline quantity selection of at least a subset of the plurality of payline quantity indicia prior to initiation of the base game based on a potential payline quantity input from a player of the base game. The apparatus also has a wager category adjuster that adjusts a potential wager category selection of at least a subset of the plurality of wager category indicia prior to initiation of the base game based on a potential wager category input from the player of the base game.

### RELATED APPLICATIONS

This patent application is a Continuation-In-Part application of U.S. patent application Ser. No. 11/938,713, filed on Nov. 12, 2007, entitled METHOD AND APPARATUS FOR A BONUS GAME HAVING A PROGRESSIVE PRIZE by Andrzej Surmacz et al., which is hereby incorporated by reference in its entirety.

### BACKGROUND

1. Field

This disclosure generally relates to the field of gaming. More particularly, the disclosure relates to wagering for a game.

2. General Background

Various slot machine games provide some of the most popular forms of gaming. In particular, some slot machines offer a bonus game that is played after the base game. The use of the bonus game provides an added level of excitement for slot machine game players and potential slot machine game players. Further, the bonus game can offer a progressive jackpot prize, which can accumulate to be quite large, in order to further incentivize play at the slot machine.

However, the current approach limits play of the bonus game to only a portion of the players of the base game. The base game generally offers different wager categories, e.g., “one x”, “two x”, “three x”, “four x”, and “five x”, from which the player selects. The selected wager category is then multiplied by the minimum wager, e.g., one dollar, to determine the player's wager. For example, a selection of the wager category “three x” equals a wager by the player of three dollars. Each of those wager categories generally corresponds to a fixed prize that is typically far less than the progressive jackpot prize, which can accumulate based on wagers. Only the players that provide the maximum wager, e.g., five dollars, are allowed to play for the top prize in the bonus round. Once the bonus round is reached, there is only one jackpot prize.

As a result, players having an interest in making a lower wager are discouraged from playing the base game. These players realize that their wagers are being utilized to contribute to a progressive jackpot prize in which they do not get to participate. Accordingly, the current approach to progressive slot machines actually discourages some potential players from playing the base game.

### SUMMARY

In one aspect of the disclosure, an apparatus is provided. The apparatus includes a slider controller that displays, prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with a bonus game. The bonus game is a game of chance that a player of the base game is eligible to play if a criterion is met. Further, the apparatus has a wager display that displays the plurality of distinct wager categories corresponding to play in the base game and the bonus game. In addition, the apparatus has a payline quantity adjuster that adjusts a potential payline quantity selection of at least a subset of the plurality of payline quantity indicia prior to initiation of the base game based on a potential payline quantity input from a player of the base game. The apparatus also has a wager category adjuster that adjusts a potential wager category selection of at least a subset of the plurality of wager category indicia prior to initiation of the base game based on a potential wager category input from the player of the base game. Further, the apparatus has a slider indicator that is displayed to indicate a quantity of indicia in the potential payline quantity selection and moves in conjunction with an adjustment to the potential payline quantity selection prior to initiation of the base game. In addition, the apparatus has a slider prize display that displays a potential prize value that results from a quantity of indicia in the potential payline quantity selection being multiplied by a quantity of indicia in the potential wager category selection. The apparatus also has a base game initiation module that receives an input from the player indicating an actual payline quantity selection and an actual wager category selection to initiate the base game. Further, the apparatus has a calculation module that calculates the known distinct portion of the prize associated with the bonus game by multiplying the actual payline quantity selection by the actual wager category selection. In addition, the apparatus has a bonus game initiation module that initiates the bonus game if the criterion is met. Finally, the apparatus has a prize distribution module that provides the known distinct portion of the prize associated with the actual wager category selection and also with the bonus game to a player if the player has a winning combination in the bonus game.

In another aspect of the disclosure, a process is provided. The process displays, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with a bonus game. The bonus game is a game of chance that a player of the base game is eligible to play if a criterion is met. Further, the process displays, with the controller, a wager display that displays the plurality of distinct wager categories corresponding to play in the base game and the bonus game. In addition, the process adjusts, with a payline quantity adjuster operated by the controller, a potential payline quantity selection of at least a subset of the plurality of payline quantity indicia prior to initiation of the base game based on a potential payline quantity input from a player of the base game. The process also adjusts, with a wager category adjuster operated by the controller, a potential wager category selection of at least a subset of the plurality of wager category indicia prior to initiation of the base game based on a potential wager category input from the player of the base game. Further, the process indicates, with a slider indicator operated by the controller, a quantity of indicia in the potential payline quantity selection. The slider indicator moves in conjunction with an adjustment to the potential payline quantity selection prior to initiation of the base game. In addition, the process displays, with a slider prize display operated by the controller, a potential prize value that results from a quantity of indicia in the potential payline quantity selection being multiplied by a quantity of indicia in the potential wager category selection. The process also receives, with a base game initiation module operated by the controller, an input from the player indicating an actual payline quantity selection and an actual wager category selection to initiate the base game. Further, the process calculates, with a calculation module operated by the controller, the known distinct portion of the prize associated with the bonus game by multiplying the actual payline quantity selection by the actual wager category selection. In addition, the process initiates, with a bonus game initiation module operated by the controller, the bonus game if the criterion is met. Finally, the process provides, with a prize distribution module operated by the controller, the known distinct portion of the prize associated with the actual wager category selection and also with the bonus game to a player if the player has a winning combination in the bonus game.

In yet another aspect of the disclosure, a computer program product is provided. The computer program product has a computer useable medium having a computer readable program. The computer readable program when executed on a computer causes the computer to display, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with a bonus game. The bonus game is a game of chance that a player of the base game is eligible to play if a criterion is met. Further, the computer readable program when executed on the computer causes the computer to display, with the controller, a wager display that displays the plurality of distinct wager categories corresponding to play in the base game and the bonus game. In addition, the computer readable program when executed on the computer causes the computer to adjust, with a payline quantity adjuster operated by the controller, a potential payline quantity selection of at least a subset of the plurality of payline quantity indicia prior to initiation of the base game based on a potential payline quantity input from a player of the base game. The computer readable program when executed on the computer also causes the computer to adjust, with a wager category adjuster operated by the controller, a potential wager category selection of at least a subset of the plurality of wager category indicia prior to initiation of the base game based on a potential wager category input from the player of the base game. Further, the computer readable program when executed on the computer causes the computer to indicate, with a slider indicator operated by the controller, a quantity of indicia in the potential payline quantity selection. The slider indicator moves in conjunction with an adjustment to the potential payline quantity selection prior to initiation of the base game. In addition, the computer readable program when executed on the computer causes the computer to display, with a slider prize display operated by the controller, a potential prize value that results from a quantity of indicia in the potential payline quantity selection being multiplied by a quantity of indicia in the potential wager category selection. The computer readable program when executed on the computer causes the computer to receive, with a base game initiation module operated by the controller, an input from the player indicating an actual payline quantity selection and an actual wager category selection to initiate the base game. Further, the computer readable program when executed on the computer causes the computer to calculate, with a calculation module operated by the controller, the known distinct portion of the prize associated with the bonus game by multiplying the actual payline quantity selection by the actual wager category selection. In addition, the computer readable program when executed on the computer causes the computer to initiate, with a bonus game initiation module operated by the controller, the bonus game if the criterion is met. Finally, the computer readable program when executed on the computer causes the computer to provide, with a prize distribution module operated by the controller, the known distinct portion of the prize associated with the actual wager category selection and also with the bonus game to a player if the player has a winning combination in the bonus game.

In another aspect of the disclosure, an apparatus is provided. The apparatus has a slider controller that displays, prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with the base game. Further, the apparatus includes a wager display that displays the plurality of distinct wager categories corresponding to play in the base game. In addition, the apparatus includes a payline quantity adjuster that adjusts a potential payline quantity selection of at least a subset of the plurality of payline quantity indicia prior to initiation of the base game based on a potential payline quantity input from a player of the base game. The apparatus also includes a wager category adjuster that adjusts a potential wager category selection of at least a subset of the plurality of wager category indicia prior to initiation of the base game based on a potential wager category input from the player of the base game. Further, the apparatus includes a slider indicator that is displayed to indicate a quantity of indicia in the potential payline quantity selection and moves in conjunction with an adjustment to the potential payline quantity selection prior to initiation of the base game. In addition, the apparatus has a slider prize display that displays a potential prize value that results from a quantity of indicia in the potential payline quantity selection being multiplied by a quantity of indicia in the potential wager category selection. The apparatus also has a base game initiation module that receives an input from the player indicating an actual payline quantity selection and an actual wager category selection to initiate the base game. Further, the apparatus has a calculation module that calculates the known distinct portion of the prize associated with the base game by multiplying the actual payline quantity selection by the actual wager category selection. In addition, the apparatus has a prize distribution module that provides the known distinct portion of the prize associated with the actual wager category selection and also with the base game to a player if the player has a winning combination in the base game.

In yet another aspect of the disclosure, a process is provided. The process displays, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with the base game. Further, the process displays, with the controller, a wager display that displays the plurality of distinct wager categories corresponding to play in the base game. In addition, the process adjusts, with a payline quantity adjuster operated by the controller, a potential payline quantity selection of at least a subset of the plurality of payline quantity indicia prior to initiation of the base game based on a potential payline quantity input from a player of the base game. The process also adjusts, with a wager category adjuster operated by the controller, a potential wager category selection of at least a subset of the plurality of wager category indicia prior to initiation of the base game based on a potential wager category input from the player of the base game. Further, the process indicates, with a slider indicator operated by the controller, a quantity of indicia in the potential payline quantity selection. The slider indicator moves in conjunction with an adjustment to the potential payline quantity selection prior to initiation of the base game. In addition, the process also displays, with a slider prize display operated by the controller, a potential prize value that results from a quantity of indicia in the potential payline quantity selection being multiplied by a quantity of indicia in the potential wager category selection. The process also receives, with a base game initiation module operated by the controller, an input from the player indicating an actual payline quantity selection and an actual wager category selection to initiate the base game. Further, the process calculates, with a calculation module operated by the controller, the known distinct portion of the prize associated with the base game by multiplying the actual payline quantity selection by the actual wager category selection. In addition, the process provides, with a prize distribution module operated by the controller, the known distinct portion of the prize associated with the actual wager category selection and also with the base game to a player if the player has a winning combination in the base game.

In another aspect of the disclosure, a computer program product is provided. The computer program product has a computer useable medium having a computer readable program. The computer readable program when executed on a computer causes the computer to display, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with the base game. Further, the computer readable program when executed on the computer causes the computer to display, with the controller, a wager display that displays the plurality of distinct wager categories corresponding to play in the base game. In addition, the computer readable program when executed on the computer causes the computer to adjust, with a payline quantity adjuster operated by the controller, a potential payline quantity selection of at least a subset of the plurality of payline quantity indicia prior to initiation of the base game based on a potential payline quantity input from a player of the base game. The computer readable program when executed on the computer also causes the computer to adjust, with a wager category adjuster operated by the controller, a potential wager category selection of at least a subset of the plurality of wager category indicia prior to initiation of the base game based on a potential wager category input from the player of the base game. Further, the computer readable program when executed on the computer causes the computer to indicate, with a slider indicator operated by the controller, a quantity of indicia in the potential payline quantity selection. The slider indicator moves in conjunction with an adjustment to the potential payline quantity selection prior to initiation of the base game. In addition, the computer readable program when executed on the computer causes the computer to display, with a slider prize display operated by the controller, a potential prize value that results from a quantity of indicia in the potential payline quantity selection being multiplied by a quantity of indicia in the potential wager category selection. The computer readable program when executed on the computer also causes the computer to receive, with a base game initiation module operated by the controller, an input from the player indicating an actual payline quantity selection and an actual wager category selection to initiate the base game. Further, the computer readable program when executed on the computer causes the computer to calculate, with a calculation module operated by the controller, the known distinct portion of the prize associated with the base game by multiplying the actual payline quantity selection by the actual wager category selection. In addition, the computer readable program when executed on the computer causes the computer to provide, with a prize distribution module operated by the controller, the known distinct portion of the prize associated with the actual wager category selection and also with the base game to a player if the player has a winning combination in the base game.

In yet another aspect of the disclosure, an apparatus is provided. The apparatus includes a slider controller that displays, prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with the base game. The base game is operated without any bonus game. The apparatus also has a wager display that displays the plurality of distinct wager categories corresponding to play in the base game. Further, the apparatus has a payline quantity adjuster that adjusts a potential payline quantity selection of at least a subset of the plurality of payline quantity indicia prior to initiation of the base game based on a potential payline quantity input from a player of the base game. In addition, the apparatus has a wager category adjuster that adjusts a potential wager category selection of at least a subset of the plurality of wager category indicia prior to initiation of the base game based on a potential wager category input from the player of the base game. The apparatus also has a slider indicator that is displayed to indicate a quantity of indicia in the potential payline quantity selection and moves in conjunction with an adjustment to the potential payline quantity selection prior to initiation of the base game. Further, the apparatus has a slider prize display that displays a potential prize value that results from a quantity of indicia in the potential payline quantity selection being multiplied by a quantity of indicia in the potential wager category selection. In addition, the apparatus has a base game initiation module that receives an input from the player indicating an actual payline quantity selection and an actual wager category selection to initiate the base game. The apparatus also has a calculation module that calculates the known distinct portion of the prize associated with the base game by multiplying the actual payline quantity selection by the actual wager category selection. Further, the apparatus has a prize distribution module that provides the known distinct portion of the prize associated with the actual wager category selection and also with the base game to a player if the player has a winning combination in the base game.

In another aspect of the disclosure, a process is provided. The process displays, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with the base game. The base game is operated without any bonus game. Further, the process displays, with the controller, a wager display that displays the plurality of distinct wager categories corresponding to play in the base game. In addition, the process adjusts, with a payline quantity adjuster operated by the controller, a potential payline quantity selection of at least a subset of the plurality of payline quantity indicia prior to initiation of the base game based on a potential payline quantity input from a player of the base game. The process also adjusts, with a wager category adjuster operated by the controller, a potential wager category selection of at least a subset of the plurality of wager category indicia prior to initiation of the base game based on a potential wager category input from the player of the base game. Further, the process indicates, with a slider indicator operated by the controller, a quantity of indicia in the potential payline quantity selection. The slider indicator moves in conjunction with an adjustment to the potential payline quantity selection prior to initiation of the base game. The process also displays, with a slider prize display operated by the controller, a potential prize value that results from a quantity of indicia in the potential payline quantity selection being multiplied by a quantity of indicia in the potential wager category selection. Further, the process receives, with a base game initiation module operated by the controller, an input from the player indicating an actual payline quantity selection and an actual wager category selection to initiate the base game. In addition, the process calculates, with a calculation module operated by the controller, the known distinct portion of the prize associated with the base game by multiplying the actual payline quantity selection by the actual wager category selection. The process also provides, with a prize distribution module operated by the controller, the known distinct portion of the prize associated with the actual wager category selection and also with the base game to a player if the player has a winning combination in the base game.

In yet another aspect of the disclosure, a computer program product is provided. The computer program product has a computer useable medium having a computer readable program. The computer readable program when executed on a computer causes the computer to display, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game. Each of the wager category indicia corresponds to one of a plurality of distinct wager categories that is associated with a known distinct portion of a prize associated with the base game. The base game is operated without any bonus game. Further, the computer readable program when executed on the computer causes the computer to display, with the controller, a wager display that displays the plurality of distinct wager categories corresponding to play in the base game. In addition, the computer readable program when executed on the computer causes the computer to adjust, with a payline quantity adjuster operated by the controller, a potential payline quantity selection of at least a subset of the plurality of payline quantity indicia prior to initiation of the base game based on a potential payline quantity input from a player of the base game. The computer readable program when executed on the computer also causes the computer to adjust, with a wager category adjuster operated by the controller, a potential wager category selection of at least a subset of the plurality of wager category indicia prior to initiation of the base game based on a potential wager category input from the player of the base game. Further, the computer readable program when executed on the computer causes the computer to indicate, with a slider indicator operated by the controller, a quantity of indicia in the potential payline quantity selection. The slider indicator moves in conjunction with an adjustment to the potential payline quantity selection prior to initiation of the base game. In addition, the computer readable program when executed on the computer causes the computer to display, with a slider prize display operated by the controller, a potential prize value that results from a quantity of indicia in the potential payline quantity selection being multiplied by a quantity of indicia in the potential wager category selection. The computer readable program when executed on the computer also causes the computer to receive, with a base game initiation module operated by the controller, an input from the player indicating an actual payline quantity selection and an actual wager category selection to initiate the base game. Further, the computer readable program when executed on the computer causes the computer to calculate, with a calculation module operated by the controller, the known distinct portion of the prize associated with the base game by multiplying the actual payline quantity selection by the actual wager category selection. In addition, the computer readable program when executed on the computer causes the computer to provide, with a prize distribution module operated by the controller, the known distinct portion of the prize associated with the actual wager category selection and also with the base game to a player if the player has a winning combination in the base game.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates progressive slot system that can be utilized to implement the base game and the bonus game.

FIG. 2 illustrates an expanded view of the first base game-bonus game station shown in FIG. 1.

FIG. 3 illustrates a process that may be utilized to transition from play of the first game to play of the second game.

FIG. 4 illustrates a process that may be utilized in providing play of the base game in conjunction with the bonus game.

FIG. 5 illustrates a computing environment that may be utilized to implement the base game in conjunction with the bonus game.

FIG. 6 illustrates a display that may be utilized with a gaming apparatus.

FIGS. 7A-7C illustrate the display illustrated in FIG. 6 in which the player makes adjustments to a potential selection of a payline and a wager category.

In the example illustrated in FIG. 7A, the player may select one payline for one cent.

In the example illustrated in FIG. 7B, the player may select ten paylines each for five cents.

In the example illustrated in FIG. 7C, the player may select all the paylines, e.g. twenty five paylines, each for five cents for the maximum wager of one dollar twenty five cents.

FIG. 8 illustrates the display illustrated in FIG. 6 with an idle message display 802.

FIG. 9 illustrates a process that provides the slider display illustrated in FIG. 6.

FIG. 10 illustrates a display 1000 that may be utilized with a gaming apparatus.

FIGS. 11A-11C illustrate the display illustrated in FIG. 11 in which the player makes adjustments to a potential selection of a payline and a wager category.

In the example illustrated in FIG. 11A, the player may select one payline for one cent to determine a potential prize payout for the base game.

In the example illustrated in FIG. 11B, the player may select ten paylines each for five cents to determine a potential prize payout for the base game.

In the example illustrated in FIG. 11C, the player may select all the paylines, e.g. twenty five paylines, each for five cents for the maximum wager of one dollar twenty five cents to determine a potential prize payout for the base game.

FIG. 12 illustrates a block diagram of a station or system that composes and provides a slider display.

### DETAILED DESCRIPTION

A method and apparatus are disclosed that allow a player of a base game to enter a bonus round without having made the maximum wager in the base game. The player can then win a portion of the progressive jackpot prize in the bonus game based on the wager category selected by the player in the base game. Accordingly, players that would normally be discouraged from playing the base game are now given an opportunity to be eligible for the bonus game. In other words, the criterion for entry into the bonus game is wager amount independent, as will be discussed below, so that all players have a chance at entering the bonus round. Further, the game provider is also incentivized as the players that make wagers from the lower wager categories are only provided with a portion of the progressive jackpot in the bonus round. The base game described herein is at times referred to as the first game, and the bonus game described herein is at times referred to as the second game.

The method and apparatus can be utilized with a variety of games. The base game and bonus game can be selected from games such as slots, poker, blackjack, bingo, etc. Further, the base game and the bonus game can be selected from games considered Class II or Class III. In one embodiment, the same type of game is utilized for both the base game and the bonus game, e.g., the base game is bingo and the bonus game is bingo. In another embodiment, different types of games are utilized for the base game and the bonus game, e.g., the base game is poker and the bonus game is bingo. A class III game can even be utilized for the base game while a class II game is utilized for the bonus game.

Further, the method and apparatus can be provided by a game provider in a variety of contexts. For example, the method and apparatus are utilized in a casino. The method and apparatus can also be utilized in locations, other than casinos, in which games are provided and wagers are received. The method and apparatus can even be provided virtually through a network, such as the Internet.

A win in either the base game or the bonus game is generally determined by a matching of some combination of symbols. A player combination of symbols is determined for the combination of symbols utilized by the player. The player combination may be selected by the player, randomly generated, or pre-established. Further, a wining combination of symbols is the combination of symbol that yields a win in the base game or the bonus game. The winning combination of symbols may be randomly generated or pre-established.

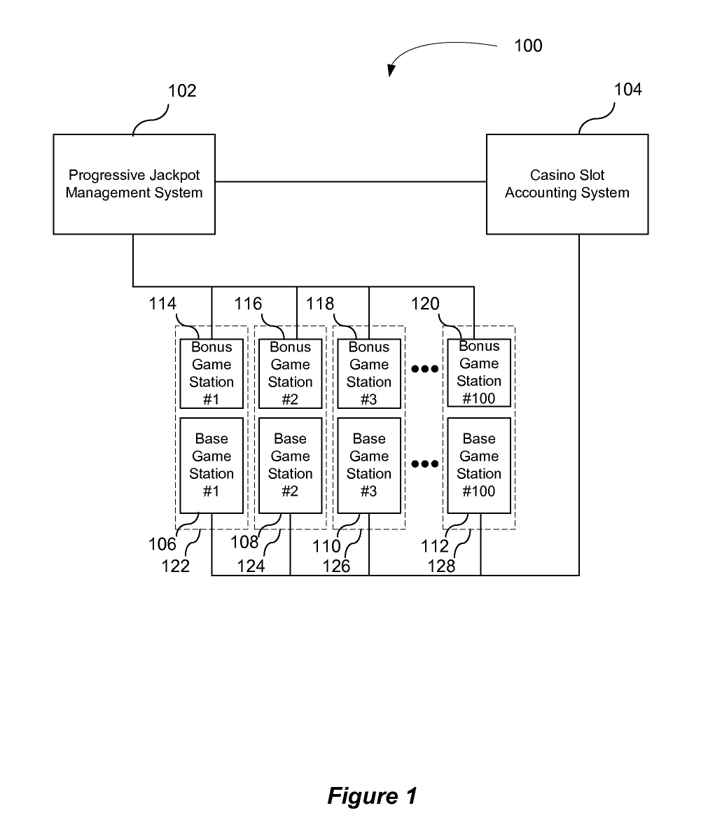

FIG. 1 illustrates progressive slot system 100 that can be utilized to implement the base game and the bonus game. The casino implementation is provided merely as an example and is not intended to limit use of the method and apparatus to that context as the method and apparatus can be utilized in any context in which a game provider provides games electronically, mechanically, virtually, or the like. Mechanical slot machines, stations displaying electronic slot games, video lottery terminals (“VLTs”), computers accessing electronic versions of the game through the Internet, etc., can be utilized to play the base game in conjunction with the bonus game according to the method and apparatus described herein.

The casino may have a plurality of base game stations, e.g., a first base game station 106, a second base game station 108, a third base game station 110, . . . , a one hundredth base game station 112. These base game stations may be utilized to provide players with the base game. In a casino setting, the base game can be any of the conventional casino games. The base game can even be a non-conventional casino game. In one embodiment, a casino slot accounting system 104 is utilized to monitor the activities of the plurality of base game stations.

Further, the casino may have a plurality of bonus game stations, e.g., a first bonus game station 114, a second bonus game station 116, a third bonus game station 118, . . . , a one hundredth bonus game station 120. These bonus game stations may be utilized to provide players with the bonus game. In a casino setting, the bonus game can be any of the conventional casino games or potentially a non-conventional casino game that is utilized for play with the conventional casino base game. Alternatively, both the bonus game and the base game can be non-conventional casino games. In one embodiment, the prize for the bonus game is a progressive jackpot, which accumulates in size based on wagers from players of the base game. A progressive jackpot management system may be utilized to manage the bonus game stations.

In one embodiment, a bonus game station is operably connected to a base game station to allow for play of the base game and the bonus game. The connection may be through cable, wireless communication, network connection, or the like. In one embodiment, casinos or other game providers can utilize existing base game stations and attach the bonus game station without having to reconfigure the bonus game station. Further, each of the bonus game stations can even be attached to different types of base game stations. For example, the first bonus game station 114 and the second bonus game station 116 may both provide a bingo game and provide a prize from the same progressive jackpot, but the first bonus game station 114 may be attached to the first base game station 106, which provides a video poker game, and the second bonus game station 116 may be attached to the second base game station 108, which provides a spinning reels game. Even though the base games are different, the wagers from both of these base games are contributed to the progressive jackpot of the bonus game. In one embodiment, a separate printer is implemented in the bonus game station to allow a winner of the bonus game to cash out separately from any potential winnings in the base game. This configuration helps provide compatibility of the bonus game station with different types of base game stations.

In another embodiment, the bonus game station and the base game station can be implemented on one device. For example, a machine with a single monitor can be utilized to play electronic versions both games. The same type of game, e.g., bingo for the base game and bingo for the bonus game, with different prizes may even be utilized.

Irrespective of the type of configuration or connection that is utilized, a plurality of base game-bonus game stations may be utilized by a casino or other game provider to provide the combination of the base game and the bonus game. For example, a first base game-bonus game station 122 includes the first base game station 106 and the first bonus game station 114, a second base game-bonus game station 124 includes the second base game station 108 and the second bonus game station 116, a third base game-bonus game station 126 includes the third base game station 110 and the third bonus game station 118, . . . , a one hundredth base game-bonus game station 128 includes the one hundredth base game station 112 and the one hundredth bonus game station 120.

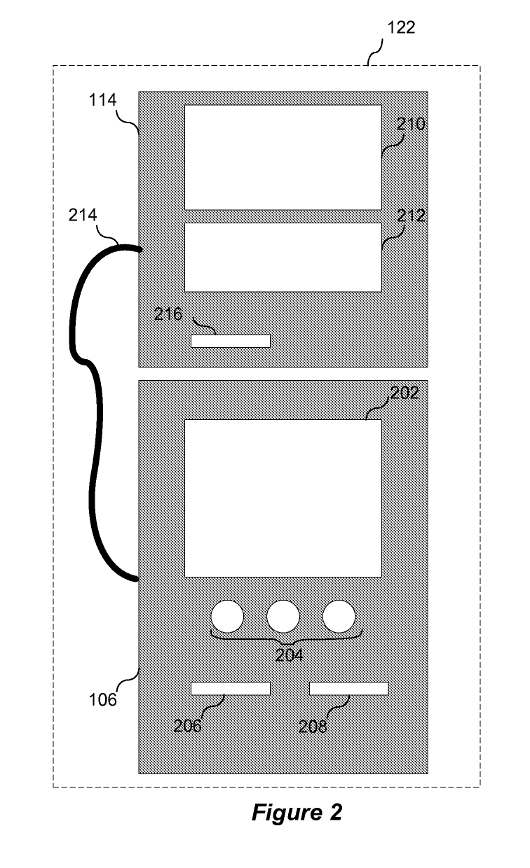

FIG. 2 illustrates an expanded view of the first base game-bonus game station 122 shown in FIG. 1. The first base game station 106 includes a display 202 in which play of the base game can be viewed. The display 202 may be an electronic display, an assortment of mechanical reels, etc. Further, the first base game station 106 has a plurality of buttons 204 that may be utilized to select a wager category, select a payline, initiate play of the base game and/or bonus game, etc. Further, the first base game station 106 has a wager acceptor 206, e.g., a bill acceptor, coin acceptor, promotional voucher acceptor, credit card acceptor, debit card acceptor, electronic wallet such as a smart card, etc., that accepts a wager from the player. In addition, the first base game station 106 has a ticket printer 208 that may be utilized to print a ticket to redeem a prize. In one embodiment, the ticket is solely for a prize won in the base game. In another embodiment, the ticket may be for a prize won in the base game and/or a prize won in the bonus game.

The display 202 may be utilized to perform functions in addition to play of the bonus game. For instance, the display 202 may display a plurality of distinct wager categories prior to play of the base game. The distinct wager categories may be multiples of a minimum wager, which may also be displayed on the display 202. For example, the wager categories may be “one x”, “two x”, “three x”, “four x”, and “five x” of a minimum wager of one dollar. The actual wager is then determined by the wager category selected by the player. For example, a wager of three dollars is made if the player selects the wager category “three x.” The wager categories may also be denominations, i.e., fractions, of a maximum wager. For example, the wager categories may be “one-fifth,” “two-fifths,” “three-fifths,” “four-fifths,” and “five-fifths” of a maximum wager of five dollars. For example, a wager of two dollars is made if a player selects the wager category “two-fifths.” The wager categories may also state the wagers directly. For example, the wager categories may be “one dollar,” “two dollars,” “three dollars,” “four dollars,” and “five dollars.” A variety of other wager displays may be utilized to provide the wager categories.

Further, the display 202 may also indicate the known jackpot prize for the bonus game. The selection of the wager category not only has an impact on the base game, but also the bonus game. The wager category corresponds to a known portion of the progressive jackpot prize that can be potentially won. The portion can be a percentage, numerical amount, etc. For instance, a wager category of “one x” may correspond to the possibility of winning twenty percent of the jackpot prize in the bonus game, a wager category of “two x” may correspond to the possibility of winning forty percent of the jackpot prize in the bonus game, a wager category of “three x” may correspond to the possibility of winning sixty percent of the jackpot prize in the bonus game, a wager category of “four x” may correspond to the possibility of winning eighty percent of the jackpot prize in the bonus game, and a wager category of “five x” may correspond to the possibility of winning one hundred percent of the jackpot prize in the bonus game. If the player becomes eligible for the bonus round, the known portion of the progressive jackpot prize associated with the wager category can be displayed.

In one embodiment, the base game offers a variety of prizes such as fixed prizes that depend on obtaining a predetermined assortment of symbols. Accordingly, a set of paylines is provided to indicate which fixed prizes are associated with particular paylines. For example, a payline may indicate that obtaining a row of cherries yields a fixed prize of five dollars while another payline may indicate that obtaining a diagonal of oranges yields a fixed prize of ten dollars. Another function that may be performed by the display 202 is providing a display of paylines. A player may select a particular payline, some of the paylines, or all of the paylines for play in the base game. In one embodiment, the number of paylines is a multiplier of the wager determined by the selection of the wager categories and can be utilized to determine the known distinct portion of the progressive jackpot prize that can be won in the bonus game.

Functions such as the display of the plurality of distinct wager categories or display of the paylines can also be provided through other components of the first base game-bonus game station 122. For instance, a printed game glass can be positioned at on the first base game-bonus game station 122 to display this information. Alternatively, a display 210 that is utilized by the bonus game station 114 to display play of the bonus game may be utilized to display this information. In yet another alternative, a display 212, which is utilized to display jackpot prize information for the bonus game, may display this information. The display 210 and the display 212 may be provided on the same display screen or separate display screens.

In one embodiment, play of the bonus game is wager amount independent. In other words, eligibility for play in the bonus round is based on factors other than the wager amount. The wager amount has an impact on the known portion of the jackpot prize that can be won in the bonus round, but does not impact the entry into the bonus game. For example, a criterion can be established to provide that play of the bonus game is dependent on a display of particular symbols in the base game, whether or not there is a win in the base game. For instance, the criterion may be a display pattern such as two consecutive cherries displayed anywhere during play of the base game. The criterion may be a game count. In other words, every fiftieth play of the base game at a particular base game station provides eligibility into the bonus game.

If the player is eligible to enter the bonus game, the bonus game is displayed for play on the display 210. This configuration is provided as an example as the base game and bonus game could be played on the same display. In this configuration, the first bonus game station 114 is operably connected to the first base game station 106 through a cable 214. Accordingly, data from the base game, e.g., wager category selected by the player, can be provided to the first bonus game station 114. In one embodiment, the cable (or other communication medium) provides two-way communication between the first bonus game station 114 and the first base game station 106 such that the bonus game station 114 can provide information regarding the progressive jackpot to be displayed by the first base game station 106 and the first base game station 106 can provide information regarding the wager categories to the first game bonus station 114 to be displayed by the first game bonus station 114. However, in another embodiment, the one-way communication can be established such that the first bonus game station 114 only receives information from the first base game station 106. For instance, the first bonus game station 114 can receive information regarding the wager categories. Further, the first bonus game station 114 can display the progressive jackpot on the display 212 along with the wager categories. Therefore, a player can view a top display of the potential portions of the jackpot prize corresponding to wager categories that are applicable to play in the base game and the bonus game.

After play of the bonus game is initiated, the display 212 can also display the wager categories and corresponding levels of the jackpot prize that can be won with each wager category. In addition, the display 212 can indicate the level of the jackpot prize that the player can potentially win. This indication may be provided as a percentage of the jackpot prize, the numerical amount that would be received, etc. Alternatively, only the actual level of the jackpot prize that can be potentially won, without the other levels of the jackpot prize that are no longer applicable, is displayed play of the bonus game is initiated.

The first bonus game station 116 does not need to have a wager acceptor as the wager acceptor utilized in the first base game station 106 receives a wager that is applicable to both the base game and the bonus game. In one embodiment, the first bonus game station 116 includes a ticket printer 216 to print a ticket so that the portion of the progressive jackpot prize that is won can be redeemed. In another embodiment, the ticket printer 206 utilized by the first base game station 106 may be utilized to print tickets for prize redemption in both the base game and the bonus game.

In one embodiment, one or more controllers may be utilized to perform functions such as initiating play of the games. For instance, the first base game station 106 may have a controller for initiating play of the base game, and the first bonus game station 116 may have a controller for initiating play of the bonus game.

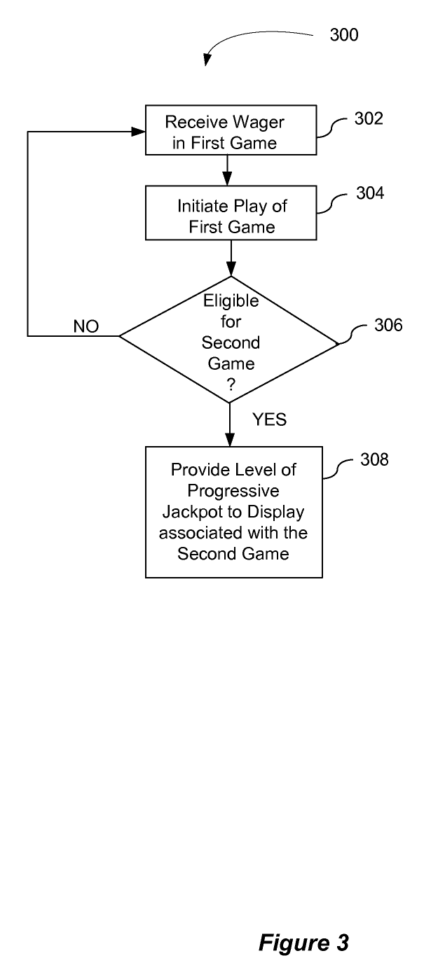

FIG. 3 illustrates a process 300 that may be utilized to transition from play of the first game to play of the second game. At a process block 302, the process 300 receives a wager in the first game. Further, at a process block 304, the process 300 initiates play of the first game. In addition, at a decision block 306, the process 300 determines if the player is eligible for the second game. In one embodiment, a criterion that is wager amount independent, as discussed above, can be utilized to determine the player's eligibility for the second game. In another embodiment, the games may be configured so that a player of the first game is always eligible for the second game. If the player is not eligible for the second game, the process 300 proceeds to the process block 302 to receive another wager in the first game from the same player or a different player. If the player is eligible for the second game, the process 300 proceeds to a process block 308 to provide the level of the progressive jackpot associated with the wager category selected by the player to the display associated with the second game.

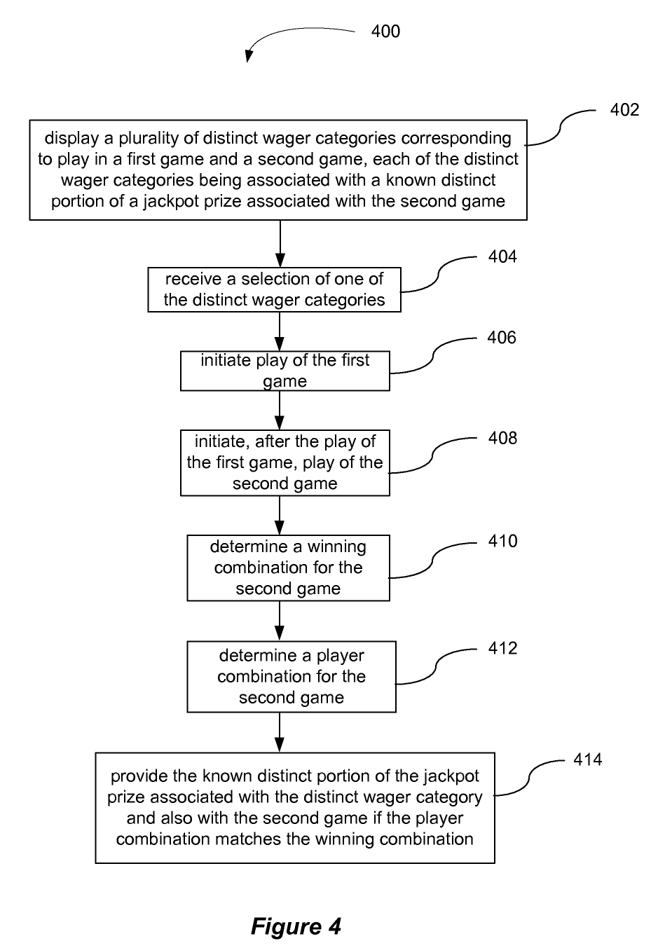

FIG. 4 illustrates a process 400 that may be utilized in providing play of the base game in conjunction with the bonus game. At a process block 402, the process 400 displays a plurality of distinct wager categories corresponding to play in a first game and a second game. Each of the distinct wager categories is associated with a known distinct portion of a jackpot prize associated with the second game. Further, at a process block 404, the process 400 receives a selection of one of the distinct wager categories. In addition, at a process block 406, the process 400 initiates play of the first game. At a process block 408, the process also initiates, after the play of the first game, play of the second game. Further, at a process block 410, the process 400 determines a winning combination for the second game. In addition, at a process block 412, the process 400 determines a player combination for the second game. Finally, at a process block 414, the process 400 provides the known distinct portion of the jackpot prize associated with the distinct wager category and also with the second game if the player combination matches the winning combination.

In one embodiment, the method and apparatus as discussed above can be implemented with a constant ratio based system. For example, a player can make a one dollar wager in the hope of winning a portion of the progressive jackpot that equals twenty percent. The player can also make a two dollar wager in the hope of winning a portion of the progressive jackpot that equals forty percent. A first association between the wager of one dollar and the percentage of twenty percent can be the quotient of twenty divided by one, which equals twenty. Similarly, a second association between the wager of two dollars and the percentage of forty percent can be the quotient of forty divided by two, which equals twenty. A constant ratio exists when the first association equals the second association. The potential portion of the jackpot prize is basically multiplied by the multiple of the lower wager that yields the higher wager.

In another embodiment, the method and apparatus as discussed above can be implemented with a variable ratio based system. For example, a player can make a one dollar wager in the hope of winning a portion of the progressive jackpot that equals twenty percent. The player can also make a two dollar wager in the hope of winning a portion of the progressive jackpot that equals forty five percent. A first association between the wager of one dollar and the percentage of twenty percent can be the quotient of twenty divided by one, which equals twenty. However, a second association between the wager of two dollars and the percentage of forty percent can be the quotient of forty five divided by two, which equals twenty two and one half. A variable ratio exists because the first association does not equal the second association. The variable ratio provides incentive to the player to make the higher wager because the potential portion of the jackpot prize is basically multiplied by a multiple that is larger than the multiple of the lower wager. As a result, the variable ratio provides the player with the ability to potentially win more for a wager than would be ordinarily won with a constant ratio.

In one embodiment, a game provider can provide an added level of excitement by associating the selected wager category with a particular character or symbol. The character or symbol can then be utilized throughout play of the base game and the bonus game.

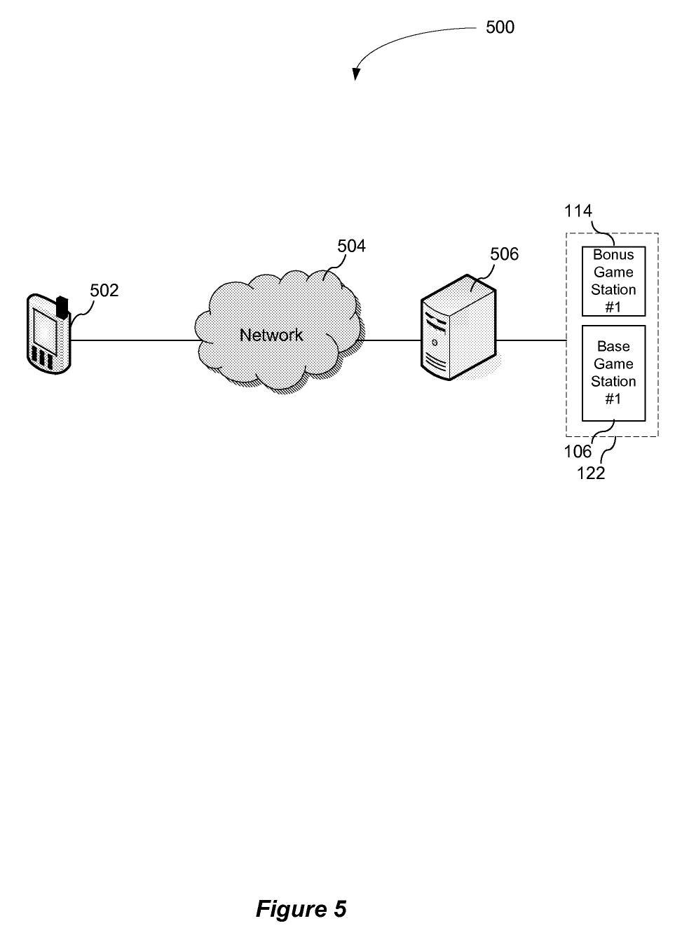

FIG. 5 illustrates a computing environment 500 that may be utilized to implement the base game in conjunction with the bonus game. An input device 502 may be utilized by a player to play the base game in conjunction with the bonus game. The input device 502 may be a PC connected to the Internet, a mobile phone, a personal digital assistant (“PDA”), a media player, or the like. Further, the player may utilize the input device 502 to communicate through a network 504 such as the Internet, a local area network (“LAN”), a wide area network (“WAN”), a mobile network, a proprietary network, or the like. The network 504 allows the input device 502 to communicate with a gaming server 506. The gaming server 506 is basically a conduit to a base game-bonus game station such as the first base game-bonus game station 122. In one embodiment, the input device 502 communicates with the game server 506 through the network 504 to the first base game station 106 in the first base game-bonus game station 122. If the bonus game is reached, the first bonus game station 114 may communicate back to the input device 502 through the game server 506 and the network 504, or the first base game station 106 may communicate data for the first bonus game station 114.

In one embodiment, the combination of the base game and the bonus game can be provided in a podcast to the input device 502. The player may subscribe to a feed for a particular type of content. The game provider may make a business arrangement with the content provider of that content such that the combination of the base game and the bonus game are pushed to the input device 502 along with the other content. The player can become aware of and play the base game in conjunction with the bonus game when viewing the content in the podcast.

Any of the configurations described herein may be utilized with a slider display. Prior to placing a total wager, i.e., determining a number of paylines and a wager category, a player may want to determine the potential portion of the prize that can be won in the bonus game. Accordingly, a visual display that may be adjusted by the player is displayed. The player can make adjustments to a potential wager category and a potential quantity of playlines to see a potential total portion of the prize that may be won.

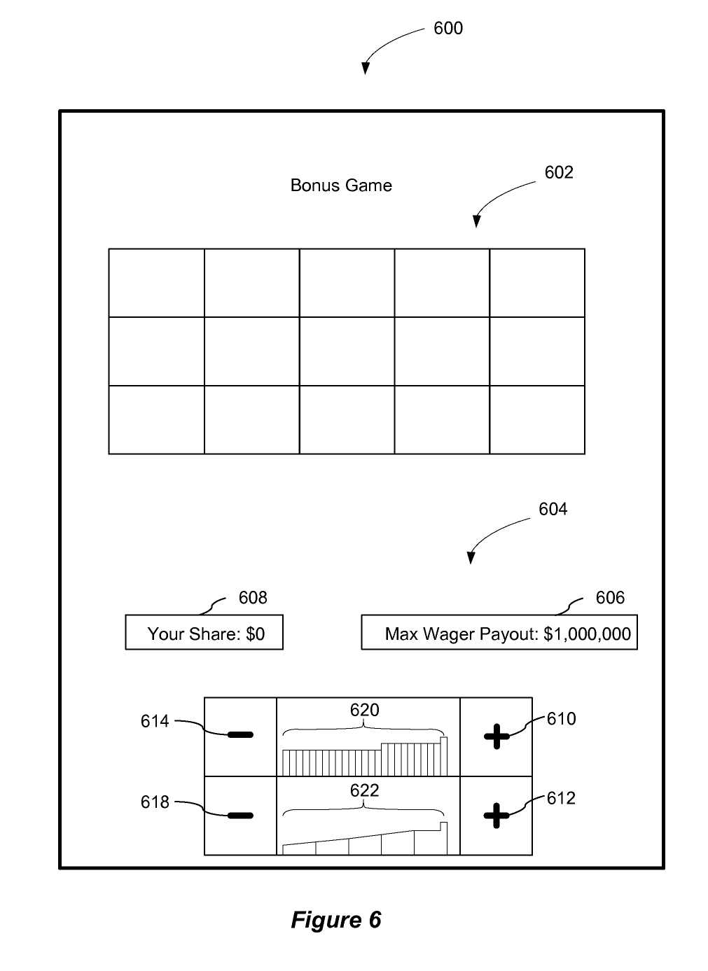

FIG. 6 illustrates a display 600 that may be utilized with a gaming apparatus. In one embodiment, the display 600 is utilized for a bonus game. The bonus game is a game of chance that a player of a base game is eligible to play if a criterion is met. The criterion may be any of the criteria described herein. Further, the bonus game may be any type of game of chance, e.g., bingo, lottery, etc. The base game has a number of distinct paylines that each have a symbol combination for which a prize may be won in the base game. The player's wager in the base game multiplied by the number of paylines chosen by the player in the base game in comparison with the total number of wager categories multiplied by the total number of paylines represents the fractional share of the prize in the bonus game that the player may win.

For illustrative purposes, a bonus game having grid format 602 is displayed in the display 600. However, the bonus game may have a variety of different formats. Accordingly, the bonus game is not limited to the grid format 602.

Prior to initiation of the base game, a slider display 604 is provided. In one embodiment, a slider controller displays the slider display 604. The slider display 604 has a slider display having a plurality of payline quantity indicia 620 and a plurality of wager category indicia 622. Each of the plurality of payline quantity indicia 620 corresponds to a distinct payline that is associated with a distinct symbol combination in the base game. For example, the base game may have twenty five different paylines such as match three apples to win one hundred dollars, three oranges to win one hundred fifty dollars, etc. For illustrative purposes, the plurality of payline quantity indicia 620 is illustrated as a plurality of bars such that each bar corresponds to one payline, but a variety of other shapes or symbols other than bars may be utilized. In one embodiment, the plurality of distinct paylines has equal increments. In another embodiment, the plurality of distinct paylines may have unequal increments. Each of the wager category indicia 622 corresponds to one of a plurality of distinct wager categories that is associated with a known distinct portion of a prize associated with a bonus game. For example, the prize for the bonus game may be one million dollars. The prize may be a progressive jackpot prize, a fixed prize, etc. An example of the plurality of distinct wager categories is each wager category being one cent. Accordingly, each plurality of wager category indicia 622 may correspond to one cent. For example, the wager categories may be one cent, two cents, three cents, four cents, and five cents. The plurality of wager category indicia may be a variety of shapes or symbols. In one embodiment, the plurality of distinct wager categories has equal increments. In another embodiment, the plurality of distinct wager categories may have unequal increments.

In one embodiment, the wager display 604 has an increment payline quantity adjuster 610 and a decrement payline quantity adjuster 614 that allows the player to adjust a potential payline quantity selection of at least a subset of the plurality of payline quantity indicia prior to initiation of the base game. The increment payline quantity adjuster 610 and a decrement payline quantity adjuster 614 are referred to collectively as the payline quantity adjuster. In one embodiment, the payline quantity adjuster may include only one input that cycles through all the possible payline quantities.

Further, in one embodiment, the wager display 604 has an increment wager category adjuster 612 and a decrement wager category adjuster 618 that allows the player to adjust a potential wager category selection of at least a subset of the plurality of wager category indicia prior to initiation of the base game. The increment wager category adjuster 612 and the decrement wager category adjuster 618 are referred to collectively as the wager category adjuster. In one embodiment, the wager category adjuster may include only one input that cycles through all the possible wager categories.

A maximum wager payout display 606 displays the prize of the bonus game that a player can win for a maximum wager. For example, if a player places a wager of five cents per payline and selects all twenty five paylines for a total wager of one dollar twenty five cents, the player can win one million dollars for winning the prize in the bonus game.

Further, a slider prize display 608 displays a potential prize value that results from a quantity of indicia in the potential payline quantity selection being multiplied by a quantity of indicia in the potential wager category selection. Since the player has not yet made a selection, the share of the player is indicated as zero dollars.

In addition, the gaming apparatus may have a wager display displays the plurality of distinct wager categories corresponding to play in the base game and the bonus game. Further, the gaming apparatus may have a base game initiation module that receives an input from the player indicating an actual payline quantity selection and an actual wager category selection to initiate the base game. In addition, the gaming apparatus may have a calculation module that calculates the known distinct portion of the prize associated with the bonus game by multiplying the actual payline quantity selection by the actual wager category selection. The gaming apparatus may also have a bonus game initiation module that initiates the bonus game if the criterion is met. Further, the gaming apparatus may have a prize distribution module that provides the known distinct portion of the prize associated with the actual wager category selection and also with the bonus game to a player if the player has a winning combination in the bonus game. The gaming apparatus may utilize a controller for the operation of the modules. The gaming apparatus may utilize any of the hardware components described herein.

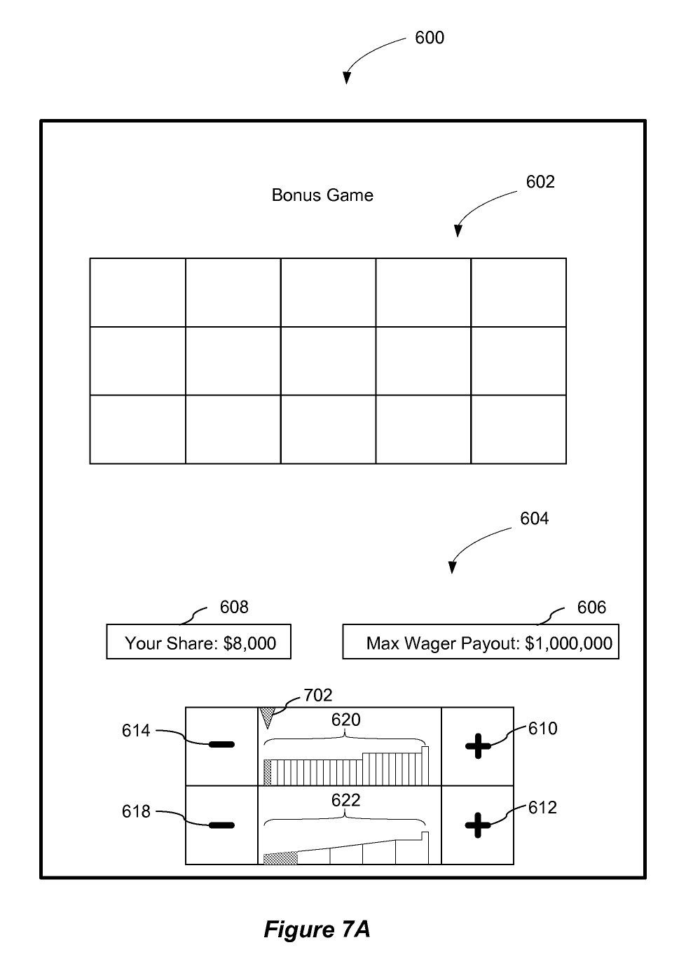

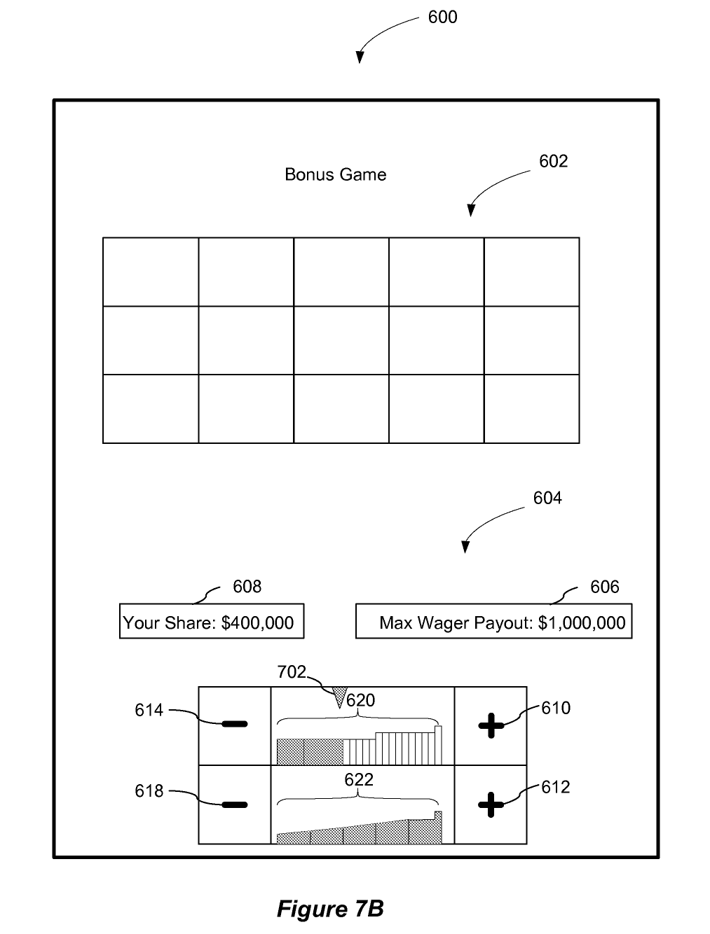

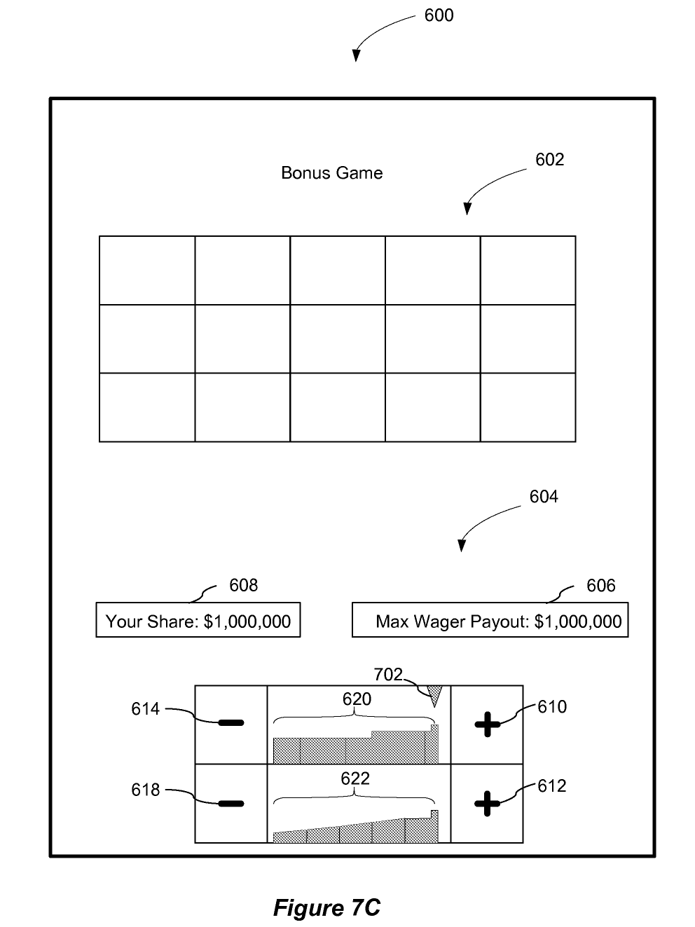

FIGS. 7A-7C illustrate the display 600 illustrated in FIG. 6 in which the player makes adjustments to a potential selection of a payline and a wager category. A slider indicator 702 is displayed to indicate a quantity of indicia in the potential payline quantity selection and moves in conjunction with an adjustment to the potential payline quantity selection prior to initiation of the base game. The slider indicator 702 is illustrated as an arrow, but may be any other shape or symbol. In embodiment, the movement of the slider indicator 702 is displayed in a sliding motion.

In the example illustrated in FIG. 7A, the player may select one payline for one cent. Accordingly, the slider indicator 702 is displayed over only one of the plurality of payline quantity indicia 620. Further, the selection of one bar in the plurality of payline quantity indicia 620 and one shape in the plurality of wager category indicia 622 are highlighted. In addition, the slider prize display 608 indicates eight thousand dollars as the share of the prize as the player receives a one out of one hundred twenty five share of the prize of one million dollars if he or she makes the wager of one cent for one payline from the one cent wager category.

In the example illustrated in FIG. 7B, the player may select ten paylines each for five cents. Accordingly, the slider indicator 702 is displayed over the tenth indicium in the plurality of payline quantity indicia 620. Further, the selection of ten bars in the plurality of payline quantity indicia 620 and five shapes in the plurality of wager category indicia 622 are highlighted. In addition, the slider prize display 608 indicates four hundred thousand dollars as the share of the prize as the player receives a fifty out of one hundred twenty five share of the prize of one million dollars if he or she makes the wager of five cents for each of ten paylines from the five cent wager category.

In the example illustrated in FIG. 7C, the player may select all the paylines, e.g. twenty five paylines, each for five cents for the maximum wager of one dollar twenty five cents. Accordingly, the slider indicator 702 is displayed over the twenty fifth indicium in the plurality of payline quantity indicia 620. Further, the selection of twenty five bars in the plurality of payline quantity indicia 620 and five shapes in the plurality of wager category indicia 622 are highlighted. In addition, the slider prize display 608 indicates one million dollars as the share of the prize that the player receives is a one hundred twenty five out of one hundred twenty five share of the prize of one million dollars if he or she makes the wager of five cents for each of twenty five paylines from the five cent wager category.

Although the slider display 604 is illustrated with respect to a bonus game for which entry is dependent on a criterion in the base game, the slider display 604 may be utilized independently of a base game and bonus game configuration. For example, the slider display 604 may be utilized with just a base game. Alternatively, the slider display 604 may be utilized with a bonus game that is not dependent on the base game for entry and/or wager. As an example, entry into the bonus game may depend on a bonus game wager in addition to a base game wager rather than a base game wager and a criterion in the base game.

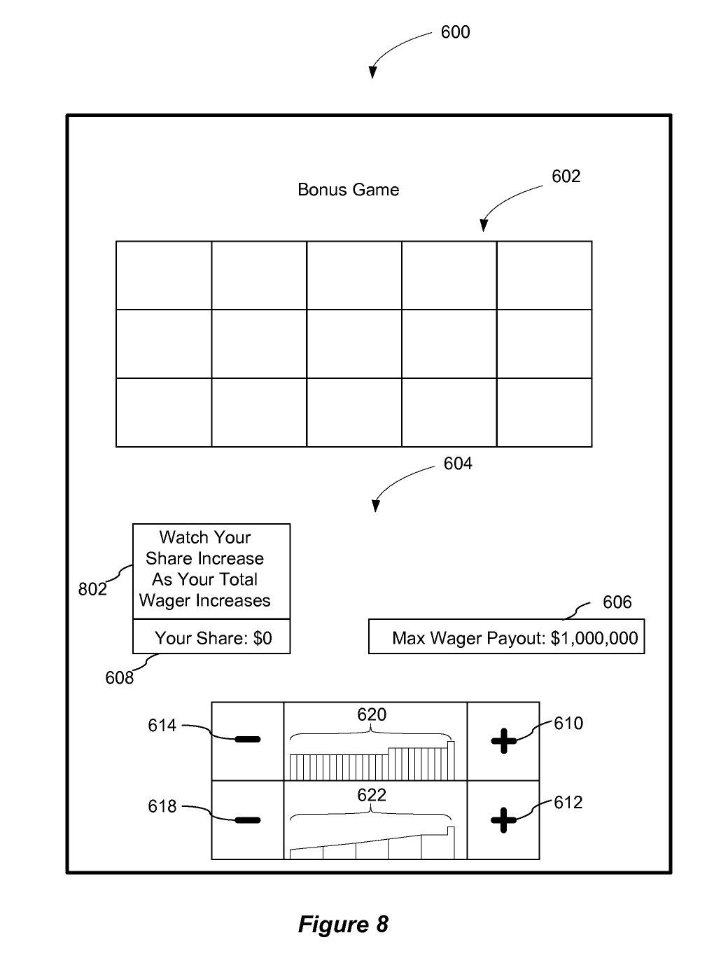

FIG. 8 illustrates the display 600 illustrated in FIG. 6 with an idle message display 802. The idle message display 802 can be displayed prior to the player making adjustments of potential selections of potential payline quantity and potential wager category and/or after the player has made some adjustments, but has not provided any input for a predetermined period of time. An example of the idle message display 802 may be “Watch Your Share As Your Total Wager Increases.”

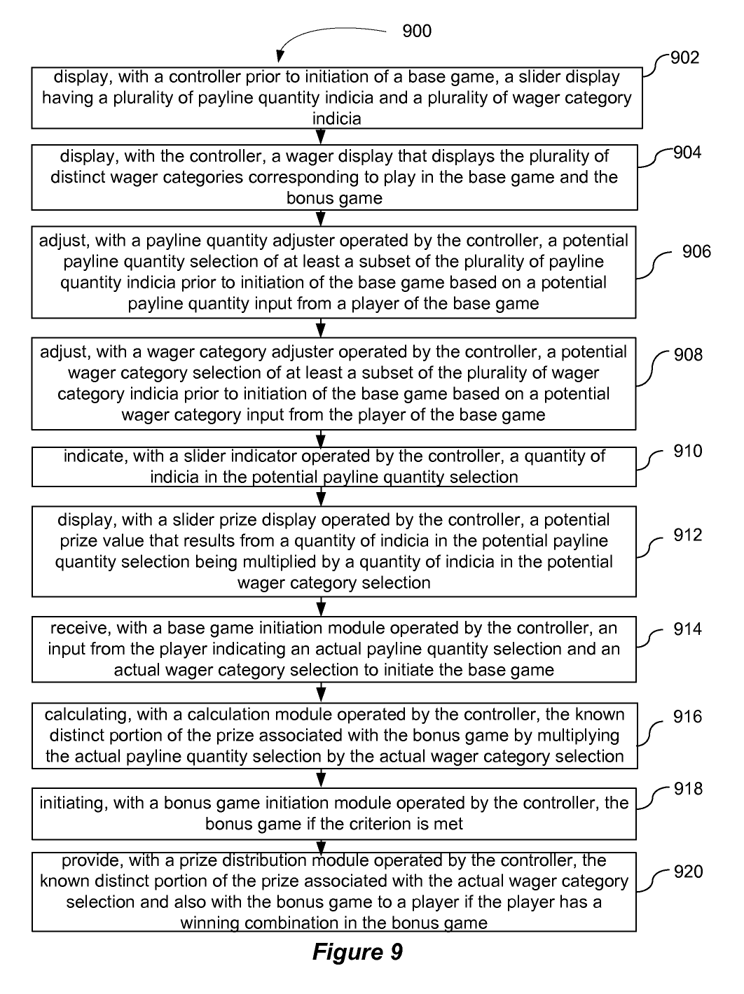

FIG. 9 illustrates a process 900 that provides the slider display 604 illustrated in FIG. 6. At a process block 902, the process 900 displays, with a controller prior to initiation of a base game, a slider display having a plurality of payline quantity indicia and a plurality of wager category indicia. Each of the plurality of payline quantity indicia corresponds to a distinct payline that is associated with a distinct symbol combination in the base game. Each of the wager category indicia corresponds to one of a plurality of distinct wager categories that is associated with a known distinct portion of a prize associated with a bonus game. The bonus game is a game of chance that a player of the base game is eligible to play if a criterion is met. Further, at a process block 904, the process 900 displays, with the controller, a wager display that displays the plurality of distinct wager categories corresponding to play in the base game and the bonus game. In addition, at a process block 906, the process 900 adjusts, with a payline quantity adjuster operated by the controller, a potential payline quantity selection of at least a subset of the plurality of payline quantity indicia prior to initiation of the base game based on a potential payline quantity input from a player of the base game. At a process block 908, the process 900 also adjusts, with a wager category adjuster operated by the controller, a potential wager category selection of at least a subset of the plurality of wager category indicia prior to initiation of the base game based on a potential wager category input from the player of the base game. Further, at a process block 910, the process 900 indicates, with a slider indicator operated by the controller, a quantity of indicia in the potential payline quantity selection. The slider indicator moves in conjunction with an adjustment to the potential payline quantity selection prior to initiation of the base game. In addition, at a process block 912, the process 900 displays, with a slider prize display operated by the controller, a potential prize value that results from a quantity of indicia in the potential payline quantity selection being multiplied by a quantity of indicia in the potential wager category selection. At a process block 914, the process 900 also receives, with a base game initiation module operated by the controller, an input from the player indicating an actual payline quantity selection and an actual wager category selection to initiate the base game. Further, at a process block 916, the process 900 calculates, with a calculation module operated by the controller, the known distinct portion of the prize associated with the bonus game by multiplying the actual payline quantity selection by the actual wager category selection. In addition, at a process block 918, the process 900 initiates, with a bonus game initiation module operated by the controller, the bonus game if the criterion is met. Finally, at a process block 920, the process 900 provides, with a prize distribution module operated by the controller, the known distinct portion of the prize associated with the actual wager category selection and also with the bonus game to a player if the player has a winning combination in the bonus game.

In an alternative embodiment, the slider display may be utilized for displaying a portion of the base game prize that can be won with a potential wager category selection and a potential number of paylines instead of the bonus game prize such that the base game is operated without a bonus game. Any of the configurations described herein may be utilized to implement such a slider display. In another embodiment, the slider display may be utilized for displaying a portion of the base game prize that can be won with a potential wager category selection and a potential number of paylines in addition to a portion of the bonus game prize that can be won with a potential wager category selection and a potential number of paylines. Any of the configurations described herein may be utilized to implement such a slider display.

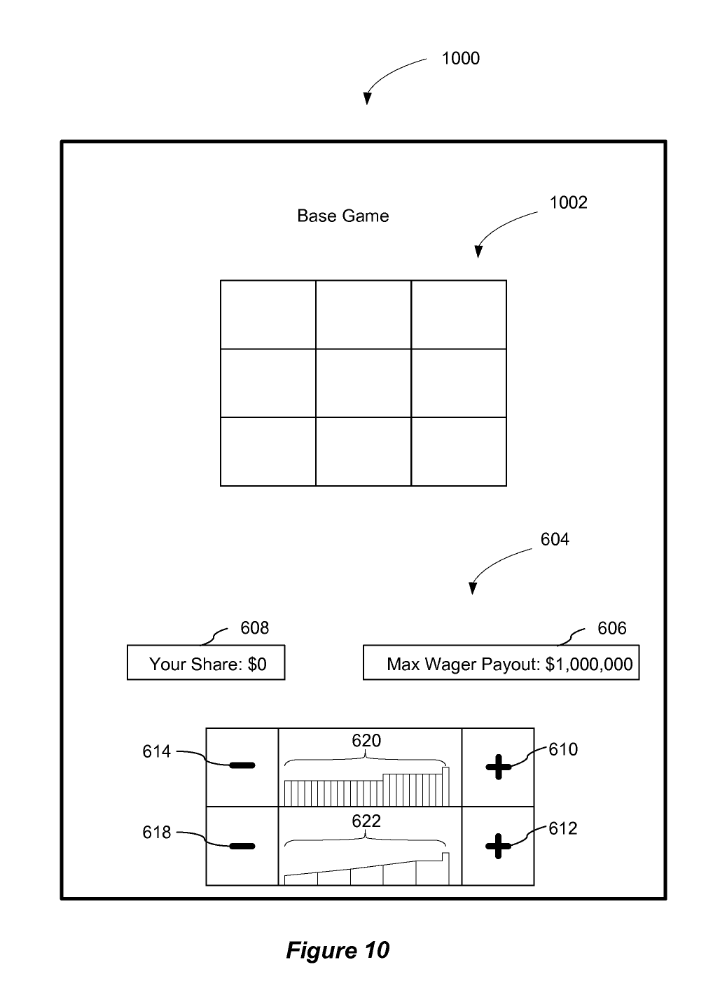

FIG. 10 illustrates a display 1000 that may be utilized with a gaming apparatus. In one embodiment, the display 1000 is utilized for base game. For illustrative purposes, a bonus game having grid format 1002 is displayed in the display 1000. However, the base game may have a variety of different formats. Accordingly, the base game is not limited to the grid format 1002. The display 1000 is operated according to the features described with respect to FIG. 6, but with the base game. In other words, the slider display 604 is utilized for purposes of the base game to allow the player to adjust a potential wager category selection and a potential number of paylines for the base game. In one embodiment, the display 1000 is utilized with a base game that operates without a bonus game. In another embodiment, the display 1000 is utilized with a base game that operates with a bonus game such that the slider display 604 is utilized for the base game and not for the bonus game. In yet another embodiment, the display 1000 is utilized with a base game that operates with a bonus game such that the slider display 604 is utilized for both the base game and the bonus game. In another embodiment, the display 1000 is utilized with a base game that operates with a bonus game such that a first slider display is utilized for the base game and a separate slider display is utilized for the bonus game.

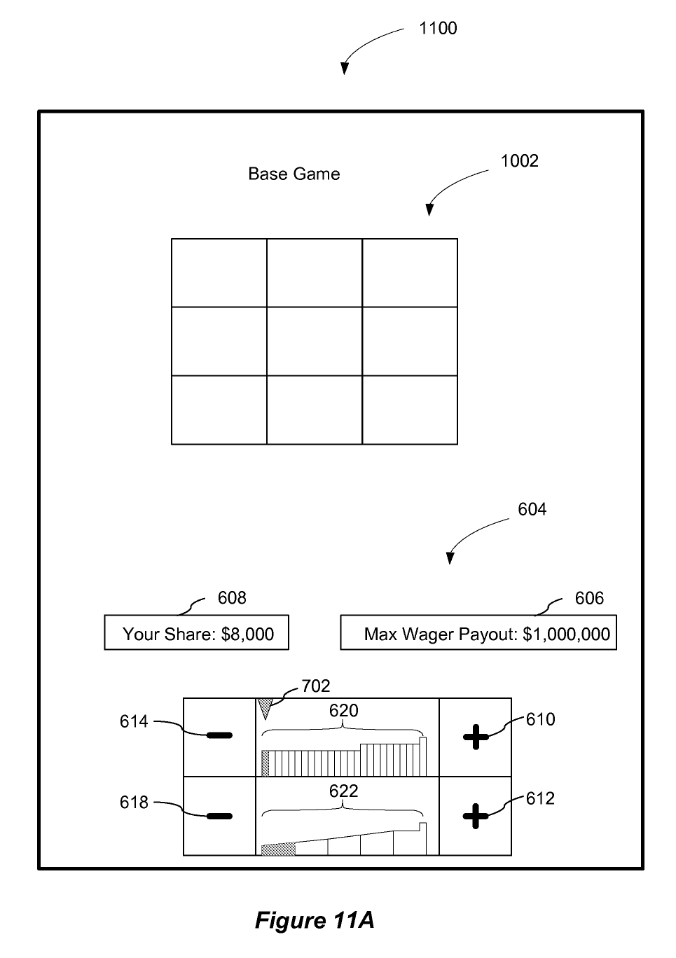

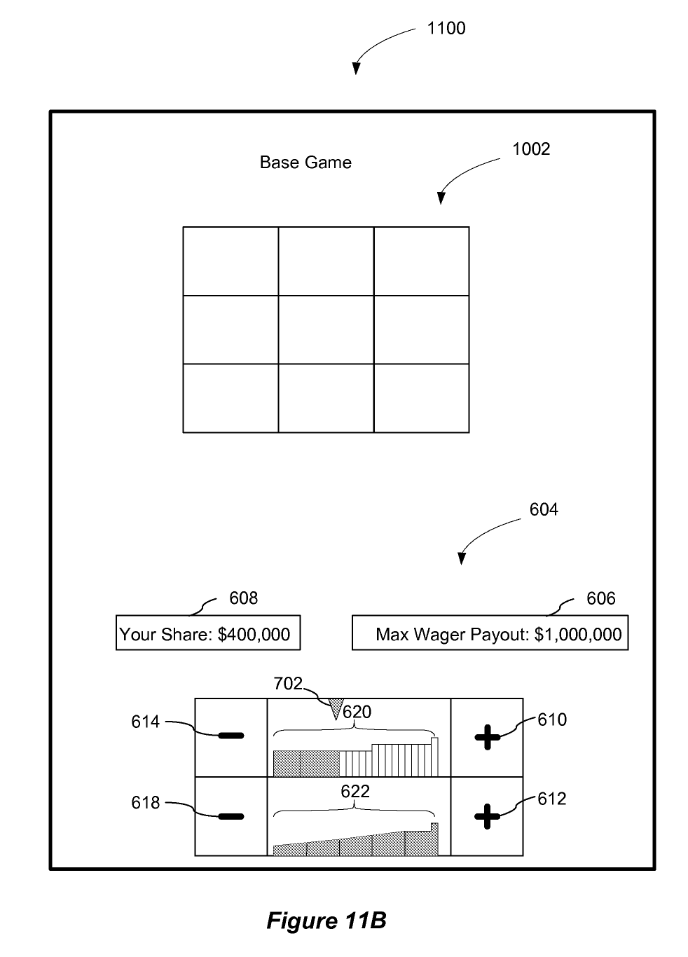

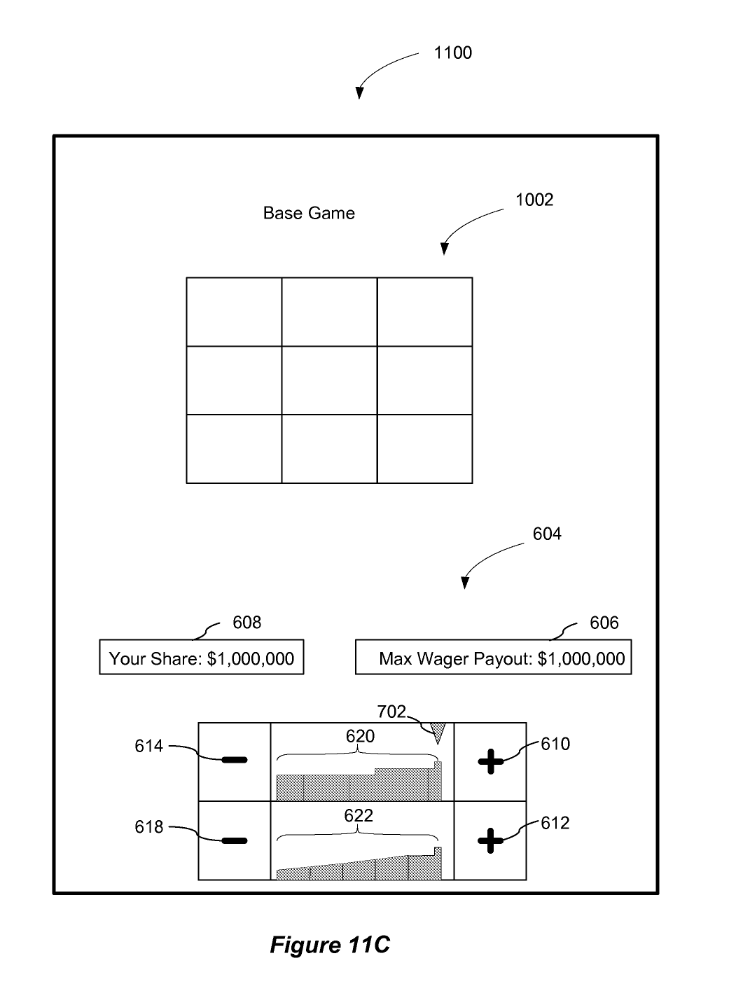

FIGS. 11A-11C illustrate the display 1100 illustrated in FIG. 11 in which the player makes adjustments to a potential selection of a payline and a wager category. In the example illustrated in FIG. 11A, the player may select one payline for one cent to determine a potential prize payout for the base game. In the example illustrated in FIG. 11B, the player may select ten paylines each for five cents to determine a potential prize payout for the base game. In the example illustrated in FIG. 11C, the player may select all the paylines, e.g. twenty five paylines, each for five cents for the maximum wager of one dollar twenty five cents to determine a potential prize payout for the base game.

The base game and/or bonus game may be any type of game. For example, a game may be mechanical, video, etc.

The processes described herein may be utilized with a base game, a bonus game, or both. The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a lottery terminal, a slot machine, a kiosk, a vending machine, a set top box (“STB”), cell phone, portable media player, or the like.

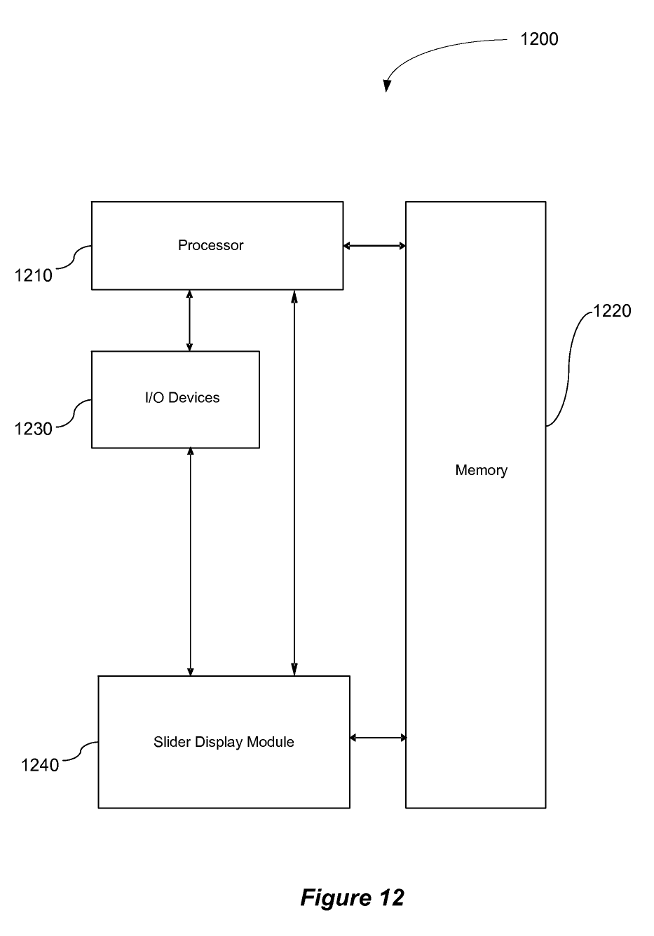

FIG. 12 illustrates a block diagram of a station or system 1200 that composes and provides a slider display. In one embodiment, the station or system 1210 is implemented utilizing a general purpose computer or any other hardware equivalents. Thus, the station or system 1200 comprises a processor 1210, a memory 1220, e.g., random access memory (“RAM”) and/or read only memory (ROM), a slider display module 1240, and various input/output devices 1230, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the slider display module 1240 may be implemented as one or more physical devices that are coupled to the processor 1210. For example, the slider display module 1240 may include a plurality of modules. Alternatively, the slider display module 1040 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 1220 of the computer. As such, the slider display module 1240 (including associated data structures) of the present disclosure may be stored on a computer readable medium, e.g., RAM memory, magnetic or optical drive or diskette and the like.

It is understood that the method and apparatus described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. An apparatus comprising:
a slider controller that displays, prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with a bonus game, the bonus game being a game of chance that a player of the base game is eligible to play if a criterion is met;
a wager display that displays the plurality of distinct wager categories corresponding to play in the base game and the bonus game;
a payline quantity adjuster that adjusts a potential payline quantity selection of at least a subset of the plurality of payline quantity indicia prior to initiation of the base game based on a potential payline quantity input from a player of the base game;
a wager category adjuster that adjusts a potential wager category selection of at least a subset of the plurality of wager category indicia prior to initiation of the base game based on a potential wager category input from the player of the base game;
a slider indicator that is displayed to indicate a quantity of indicia in the potential payline quantity selection and moves in conjunction with an adjustment to the potential payline quantity selection prior to initiation of the base game;
a slider prize display that displays a potential prize value that results from a quantity of indicia in the potential payline quantity selection being multiplied by a quantity of indicia in the potential wager category selection;
a base game initiation module that receives an input from the player indicating an actual payline quantity selection and an actual wager category selection to initiate the base game;
a calculation module that calculates the known distinct portion of the prize associated with the bonus game by multiplying the actual payline quantity selection by the actual wager category selection;
a bonus game initiation module that initiates the bonus game if the criterion is met; and
a prize distribution module that provides the known distinct portion of the prize associated with the actual wager category selection and also with the bonus game to a player if the player has a winning combination in the bonus game.

2. The apparatus of claim 1, wherein the selection of the at least the subset of the plurality of payline quantity indicia is performed by highlighting the at least the subset of the plurality of payline quantity indicia without highlighting remaining payline quantity indicia from the plurality of payline quantity indicia.

3. The apparatus of claim 1, wherein the selection of the at least the subset of the plurality of payline quantity indicia is performed by marking the at least the subset of the plurality of payline quantity indicia without highlighting remaining payline quantity indicia from the plurality of payline quantity indicia.

4. The apparatus of claim 1, wherein the game of chance is bingo.

5. The apparatus of claim 1, wherein the base game is a lottery game.

6. The apparatus of claim 1, wherein the prize is a progressive jackpot prize.

7. The apparatus of claim 1, wherein the prize is a fixed prize.

8. The apparatus of claim 1, further comprising a maximum wager prize display that displays a potential prize value that results from a selection of all the of the quantity of indicia in the potential payline quantity selection and all of the quantity of indicia in the potential wager category selection.

9. The apparatus of claim 1, wherein the slider indicator is an arrow.

10. The apparatus of claim 1, wherein the criterion comprises a display of one or more symbols during play of the first game.

11. The apparatus of claim 1, wherein the criterion comprises a game count.

12. The apparatus of claim 1, wherein the criterion is independent of wager amount.

13. The apparatus of claim 1, wherein the winning combination for the base game is determined by randomly generating the winning combination.

14. The apparatus of claim 1, wherein the plurality of payline quantity indicia is positioned parallel to the plurality of wager category indicia.

15. The apparatus of claim 1, wherein the base game is a slots game.

16. An method comprising:
displaying, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with a bonus game, the bonus game being a game of chance that a player of the base game is eligible to play if a criterion is met;
displaying, with the controller, a wager display that displays the plurality of distinct wager categories corresponding to play in the base game and the bonus game;
adjusting, with a payline quantity adjuster operated by the controller, a potential payline quantity selection of at least a subset of the plurality of payline quantity indicia prior to initiation of the base game based on a potential payline quantity input from a player of the base game;
adjusting, with a wager category adjuster operated by the controller, a potential wager category selection of at least a subset of the plurality of wager category indicia prior to initiation of the base game based on a potential wager category input from the player of the base game;
indicating, with a slider indicator operated by the controller, a quantity of indicia in the potential payline quantity selection, the slider indicator moving in conjunction with an adjustment to the potential payline quantity selection prior to initiation of the base game;
displaying, with a slider prize display operated by the controller, a potential prize value that results from a quantity of indicia in the potential payline quantity selection being multiplied by a quantity of indicia in the potential wager category selection;
receiving, with a base game initiation module operated by the controller, an input from the player indicating an actual payline quantity selection and an actual wager category selection to initiate the base game;
calculating, with a calculation module operated by the controller, the known distinct portion of the prize associated with the bonus game by multiplying the actual payline quantity selection by the actual wager category selection;
initiating, with a bonus game initiation module operated by the controller, the bonus game if the criterion is met; and
providing, with a prize distribution module operated by the controller, the known distinct portion of the prize associated with the actual wager category selection and also with the bonus game to a player if the player has a winning combination in the bonus game.

17. The method of claim 16, wherein the selection of the at least the subset of the plurality of payline quantity indicia is performed by highlighting the at least the subset of the plurality of payline quantity indicia without highlighting remaining payline quantity indicia from the plurality of payline quantity indicia.

18. The method of claim 16, wherein the selection of the at least the subset of the plurality of payline quantity indicia is performed by marking the at least the subset of the plurality of payline quantity indicia without highlighting remaining payline quantity indicia from the plurality of payline quantity indicia.

19. The method of claim 16, wherein the game of chance is bingo.

20. The method of claim 16, wherein the base game is a lottery game.

21. The method of claim 16, wherein the prize is a progressive jackpot prize.

22. The method of claim 16, wherein the prize is a fixed prize.

23. The method of claim 16, further comprising displaying, with the controller, a maximum wager prize display that displays a potential prize value that results from a selection of all the of the quantity of indicia in the potential payline quantity selection and all of the quantity of indicia in the potential wager category selection.

24. The method of claim 16, wherein the slider indicator is an arrow.

25. The method of claim 16, wherein the criterion comprises a display of one or more symbols during play of the first game.

26. The method of claim 16, wherein the criterion comprises a game count.

27. The method of claim 16, wherein the criterion is independent of wager amount.

28. The method of claim 16, wherein the winning combination for the base game is determined by randomly generating the winning combination.

29. The method of claim 16, wherein the plurality of payline quantity indicia is positioned parallel to the plurality of wager category indicia.

30. The method of claim 16, wherein the base game is a slots game.

31. A computer program product comprising a computer useable medium having a computer readable program, wherein the computer readable program when executed on a computer causes the computer to:
display, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with a bonus game, the bonus game being a game of chance that a player of the base game is eligible to play if a criterion is met;
display, with the controller, a wager display that displays the plurality of distinct wager categories corresponding to play in the base game and the bonus game;
adjust, with a payline quantity adjuster operated by the controller, a potential payline quantity selection of at least a subset of the plurality of payline quantity indicia prior to initiation of the base game based on a potential payline quantity input from a player of the base game;
adjust, with a wager category adjuster operated by the controller, a potential wager category selection of at least a subset of the plurality of wager category indicia prior to initiation of the base game based on a potential wager category input from the player of the base game;
indicate, with a slider indicator operated by the controller, a quantity of indicia in the potential payline quantity selection, the slider indicator moving in conjunction with an adjustment to the potential payline quantity selection prior to initiation of the base game;
display, with a slider prize display operated by the controller, a potential prize value that results from a quantity of indicia in the potential payline quantity selection being multiplied by a quantity of indicia in the potential wager category selection;
receive, with a base game initiation module operated by the controller, an input from the player indicating an actual payline quantity selection and an actual wager category selection to initiate the base game;
calculate, with a calculation module operated by the controller, the known distinct portion of the prize associated with the bonus game by multiplying the actual payline quantity selection by the actual wager category selection;
initiate, with a bonus game initiation module operated by the controller, the bonus game if the criterion is met; and
provide, with a prize distribution module operated by the controller, the known distinct portion of the prize associated with the actual wager category selection and also with the bonus game to a player if the player has a winning combination in the bonus game.

32. The computer program product of claim 31, wherein the selection of the at least the subset of the plurality of payline quantity indicia is performed by highlighting the at least the subset of the plurality of payline quantity indicia without highlighting remaining payline quantity indicia from the plurality of payline quantity indicia.

33. The computer program product of claim 31, wherein the selection of the at least the subset of the plurality of payline quantity indicia is performed by marking the at least the subset of the plurality of payline quantity indicia without highlighting remaining payline quantity indicia from the plurality of payline quantity indicia.

34. The computer program product of claim 31, wherein the game of chance is bingo.

35. The computer program product of claim 31, wherein the base game is a lottery game.

36. The computer program product of claim 31, wherein the prize is a progressive jackpot prize.

37. The computer program product of claim 31, wherein the prize is a fixed prize.

38. The computer program product of claim 31, wherein the computer is further caused to display a maximum wager prize display that displays a potential prize value that results from a selection of all the of the quantity of indicia in the potential payline quantity selection and all of the quantity of indicia in the potential wager category selection.

39. The computer program product of claim 31, wherein the slider indicator is an arrow.

40. The computer program product of claim 31, wherein the criterion comprises a display of one or more symbols during play of the first game.

41. The computer program product of claim 31, wherein the criterion comprises a game count.

42. The computer program product of claim 31, wherein the criterion is independent of wager amount.

43. The computer program product of claim 31, wherein the winning combination for the base game is determined by randomly generating the winning combination.

44. The computer program product of claim 31, wherein the plurality of payline quantity indicia is positioned parallel to the plurality of wager category indicia.

45. The computer program product of claim 31, wherein the base game is a slots game.

46. An apparatus comprising:
a slider controller that displays, prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game;
a wager display that displays the plurality of distinct wager categories corresponding to play in the base game;
a payline quantity adjuster that adjusts a potential payline quantity selection of at least a subset of the plurality of payline quantity indicia prior to initiation of the base game based on a potential payline quantity input from a player of the base game;
a wager category adjuster that adjusts a potential wager category selection of at least a subset of the plurality of wager category indicia prior to initiation of the base game based on a potential wager category input from the player of the base game;
a slider indicator that is displayed to indicate a quantity of indicia in the potential payline quantity selection and moves in conjunction with an adjustment to the potential payline quantity selection prior to initiation of the base game;
a slider prize display that displays a potential prize value that results from a quantity of indicia in the potential payline quantity selection being multiplied by a quantity of indicia in the potential wager category selection;
a base game initiation module that receives an input from the player indicating an actual payline quantity selection and an actual wager category selection to initiate the base game;
a calculation module that calculates the known distinct portion of the prize associated with the base game by multiplying the actual payline quantity selection by the actual wager category selection; and
a prize distribution module that provides the known distinct portion of the prize associated with the actual wager category selection and also with the base game to a player if the player has a winning combination in the base game.

47. A method comprising:
displaying, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game;
displaying, with the controller, a wager display that displays the plurality of distinct wager categories corresponding to play in the base game;
adjusting, with a payline quantity adjuster operated by the controller, a potential payline quantity selection of at least a subset of the plurality of payline quantity indicia prior to initiation of the base game based on a potential payline quantity input from a player of the base game;
adjusting, with a wager category adjuster operated by the controller, a potential wager category selection of at least a subset of the plurality of wager category indicia prior to initiation of the base game based on a potential wager category input from the player of the base game;
indicating, with a slider indicator operated by the controller, a quantity of indicia in the potential payline quantity selection, the slider indicator moving in conjunction with an adjustment to the potential payline quantity selection prior to initiation of the base game;
displaying, with a slider prize display operated by the controller, a potential prize value that results from a quantity of indicia in the potential payline quantity selection being multiplied by a quantity of indicia in the potential wager category selection;
receiving, with a base game initiation module operated by the controller, an input from the player indicating an actual payline quantity selection and an actual wager category selection to initiate the base game;
calculating, with a calculation module operated by the controller, the known distinct portion of the prize associated with the base game by multiplying the actual payline quantity selection by the actual wager category selection; and
providing, with a prize distribution module operated by the controller, the known distinct portion of the prize associated with the actual wager category selection and also with the base game to a player if the player has a winning combination in the base game.

48. A computer program product comprising a computer useable medium having a computer readable program, wherein the computer readable program when executed on a computer causes the computer to:
display, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game;
display, with the controller, a wager display that displays the plurality of distinct wager categories corresponding to play in the base game;
adjust, with a payline quantity adjuster operated by the controller, a potential payline quantity selection of at least a subset of the plurality of payline quantity indicia prior to initiation of the base game based on a potential payline quantity input from a player of the base game;
adjust, with a wager category adjuster operated by the controller, a potential wager category selection of at least a subset of the plurality of wager category indicia prior to initiation of the base game based on a potential wager category input from the player of the base game;
indicate, with a slider indicator operated by the controller, a quantity of indicia in the potential payline quantity selection, the slider indicator moving in conjunction with an adjustment to the potential payline quantity selection prior to initiation of the base game;
display, with a slider prize display operated by the controller, a potential prize value that results from a quantity of indicia in the potential payline quantity selection being multiplied by a quantity of indicia in the potential wager category selection;
receive, with a base game initiation module operated by the controller, an input from the player indicating an actual payline quantity selection and an actual wager category selection to initiate the base game;
calculate, with a calculation module operated by the controller, the known distinct portion of the prize associated with the base game by multiplying the actual payline quantity selection by the actual wager category selection; and
provide, with a prize distribution module operated by the controller, the known distinct portion of the prize associated with the actual wager category selection and also with the base game to a player if the player has a winning combination in the base game.

49. An apparatus comprising:
a slider controller that displays, prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game, the base game being operated without any bonus game;
a wager display that displays the plurality of distinct wager categories corresponding to play in the base game;
a payline quantity adjuster that adjusts a potential payline quantity selection of at least a subset of the plurality of payline quantity indicia prior to initiation of the base game based on a potential payline quantity input from a player of the base game;
a wager category adjuster that adjusts a potential wager category selection of at least a subset of the plurality of wager category indicia prior to initiation of the base game based on a potential wager category input from the player of the base game;
a slider indicator that is displayed to indicate a quantity of indicia in the potential payline quantity selection and moves in conjunction with an adjustment to the potential payline quantity selection prior to initiation of the base game;
a slider prize display that displays a potential prize value that results from a quantity of indicia in the potential payline quantity selection being multiplied by a quantity of indicia in the potential wager category selection;
a base game initiation module that receives an input from the player indicating an actual payline quantity selection and an actual wager category selection to initiate the base game;
a calculation module that calculates the known distinct portion of the prize associated with the base game by multiplying the actual payline quantity selection by the actual wager category selection; and
a prize distribution module that provides the known distinct portion of the prize associated with the actual wager category selection and also with the base game to a player if the player has a winning combination in the base game.

50. A method comprising:
displaying, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game, the base game being operated without any bonus game;
displaying, with the controller, a wager display that displays the plurality of distinct wager categories corresponding to play in the base game;
adjusting, with a payline quantity adjuster operated by the controller, a potential payline quantity selection of at least a subset of the plurality of payline quantity indicia prior to initiation of the base game based on a potential payline quantity input from a player of the base game;
adjusting, with a wager category adjuster operated by the controller, a potential wager category selection of at least a subset of the plurality of wager category indicia prior to initiation of the base game based on a potential wager category input from the player of the base game;
indicating, with a slider indicator operated by the controller, a quantity of indicia in the potential payline quantity selection, the slider indicator moving in conjunction with an adjustment to the potential payline quantity selection prior to initiation of the base game;
displaying, with a slider prize display operated by the controller, a potential prize value that results from a quantity of indicia in the potential payline quantity selection being multiplied by a quantity of indicia in the potential wager category selection;
receiving, with a base game initiation module operated by the controller, an input from the player indicating an actual payline quantity selection and an actual wager category selection to initiate the base game;
calculating, with a calculation module operated by the controller, the known distinct portion of the prize associated with the base game by multiplying the actual payline quantity selection by the actual wager category selection; and
providing, with a prize distribution module operated by the controller, the known distinct portion of the prize associated with the actual wager category selection and also with the base game to a player if the player has a winning combination in the base game.

51. A computer program product comprising a computer useable medium having a computer readable program, wherein the computer readable program when executed on a computer causes the computer to:
display, with a controller prior to initiation of a base game, a slider display having a plurality of payline quantity indicia and a plurality of wager category indicia, each of the plurality of payline quantity indicia corresponding to a distinct payline that is associated with a distinct symbol combination in the base game, each of the wager category indicia corresponding to one of a plurality of distinct wager categories that is associated with a known distinct portion of a prize associated with the base game, the base game being operated without any bonus game;
display, with the controller, a wager display that displays the plurality of distinct wager categories corresponding to play in the base game;
adjust, with a payline quantity adjuster operated by the controller, a potential payline quantity selection of at least a subset of the plurality of payline quantity indicia prior to initiation of the base game based on a potential payline quantity input from a player of the base game;
adjust, with a wager category adjuster operated by the controller, a potential wager category selection of at least a subset of the plurality of wager category indicia prior to initiation of the base game based on a potential wager category input from the player of the base game;
indicate, with a slider indicator operated by the controller, a quantity of indicia in the potential payline quantity selection, the slider indicator moving in conjunction with an adjustment to the potential payline quantity selection prior to initiation of the base game;
display, with a slider prize display operated by the controller, a potential prize value that results from a quantity of indicia in the potential payline quantity selection being multiplied by a quantity of indicia in the potential wager category selection;
receive, with a base game initiation module operated by the controller, an input from the player indicating an actual payline quantity selection and an actual wager category selection to initiate the base game;
calculate, with a calculation module operated by the controller, the known distinct portion of the prize associated with the base game by multiplying the actual payline quantity selection by the actual wager category selection; and
provide, with a prize distribution module operated by the controller, the known distinct portion of the prize associated with the actual wager category selection and also with the base game to a player if the player has a winning combination in the base game.
